(19) United States
(12) Patent Application Publication
(10) Pub. No.: US 2013/0237249 A1
(43) Pub. Date: Sep. 12, 2013

(54) PROVIDING AND USING MAP TAGS

(71) Applicant: William M. Stewart, Lewes, DE (US)

(72) Inventor: William M. Stewart, Lewes, DE (US)

(21) Appl. No.: 13/415,041

(22) Filed: Mar. 8, 2012

(51) Int. Cl. H04W 24/00

(52) U.S. Cl. 455/456.2; 455/456.1

(57) ABSTRACT

Technology is described for associating a map tag with a location. The technology receives an identity of a creator, an indication of a geographic location, a name to be used as a moniker for the geographic location, and permission information from the creator identifying at least one user who can access an aspect of the geographic location. The technology stores, in a map tag directory that stores at least one other map tag, as a part of a newly created map tag associated with the creator, the received indication of the geographic location, name, and permission information.

### BACKGROUND

With the advent of global positioning systems (GPS) and other technologies, there are an increasing number of location-based services. Location-based services use data, e.g., map data, routing data, points of interest data, etc. to provide various services, e.g., services associated with navigation, search, recommendations, games, etc. As an example, users may attempt to navigate to points of interests identified by other users, e.g., as identified by GPS coordinates associated with a digital (“geotagged”) photograph or otherwise identified by the other users. As another example, a package delivery company may attempt to navigate to a particular street address. There is presently no easy or globally accepted mechanism to securely identify, store, and share user-identified points of interest.

In some jurisdictions, not all locations have postal street addresses. As an example, in some developing nations, people and businesses routinely use post office boxes because no postal street addresses exist. In such jurisdictions, directions are often provided in relation to landmarks. As an example, a particular location can be specified in relation to other nearby locations that are generally recognizable by the local population, e.g., road intersections, movie theaters, commercial establishments, etc. In such jurisdictions, people who are not familiar with the local area, delivery personnel for package delivery services, and others may find difficulty in navigating to or otherwise locating some locations, e.g., because they are not familiar with the specified landmarks.

### BRIEF DESCRIPTION OF THE DRAWINGS

FIG. 1 is a map diagram illustrating a map with some identified locations.

FIG. 2 is a block diagram illustrating components employed by the technology in various embodiments.

FIG. 3 is a flow diagram illustrating a routine invoked by the technology in various embodiments, e.g., for receiving and storing information relating to a map tag.

FIG. 4 is a flow diagram illustrating a routine invoked by the technology in various embodiments, e.g., for providing location information associated with a specified map tag.

FIGS. 5A and 5B are table diagrams illustrating tables that may be employed by the technology in various embodiments, e.g., to store information relating to map tags.

FIG. 6 is a block diagram illustrating components employed by the technology in various embodiments.

FIG. 7 is a table diagram illustrating a table that may be employed by the technology in various embodiments, e.g., to store events associated with map tags.

FIG. 8 is a flow diagram illustrating a routine invoked by the technology in various embodiments, e.g., for providing navigation information to a location associated with a specified map tag.

FIG. 9 is a block diagram illustrating components employed by the technology in various embodiments.

FIG. 10 is a user interface diagram illustrating a user interface provided by the technology in various embodiments.

FIG. 11 is a block diagram illustrating components employed by the technology in various embodiments.

FIG. 12 is a flow diagram illustrating a routine invoked by the technology in various embodiments, e.g., for registering users.

### DETAILED DESCRIPTION

Technology for providing and using “map tags” (“the technology”) is described. A “map tag” is a collection of information that can be securely stored and shared. The collection of information can include geo-data (e.g., GPS coordinates), identifiers of objects associated with the geo-data, and identification of parties and their privileges associated with the map tags. A party can be a user, e.g., a natural person, a legal entity, etc. As an example, a user may create a map tag and indicate that family can view all aspects of the map tag, friends can determine in which city the map tag is located, and a specified package delivery company can identify the present location of the map tag in detail. A map tag becomes a named identifier for a location that others can use, e.g., to navigate to the location. A user may create multiple map tags, e.g., for the user's personal points of interest (home, office, school, store, car, etc.) and share the created map tags with others the user desires to share location information with in a secure manner.

A user can share a map tag with a different user, e.g., by providing a uniform resource locator (URL) to the other user. The URL may specify a domain and an indicator of a map tag. The indicator of a map tag can be a globally unique identifier or an identifier unique to the specified domain. As an example, the map tag can be “location-name@user.MT” and the URL can be domain/location-name@user.MT wherein the domain can be a fully qualified-domain name (e.g., a domain name that is one or two levels below a top-level domain). An example of a fully-qualified domain name is www.mymaptag.com. The technology or its users may follow a map tag naming convention for map tags, e.g., Map-tag-name@Map-tag-owner.Map-tag-top-level-domain. The map tag top level domain is not necessarily the same Web domain as the domain name of the service that provides the map tag service. Thus, the map tags can become “user friendly” monikers for complex location information. Users can employ any electronic means for sharing data, e.g., e-mail, social networking, instant messaging, phone text messaging, etc. by providing the URL. Alternatively, users can share simply the map tags (e.g., not as a URL) if they expect the recipient to know how to handle the map tag without the URL. Various names and domains may be reserved (e.g., “vanity”) to support trademark holders. Map tags enable the sharing of potentially sensitive, private location information via non-secure methods without disclosing the actual physical location to unauthorized parties.

In various embodiments, the technology can include a map tags directory. The map tags directory stores the collection of information associated with map tags. In various embodiments, users may be encouraged to store map tags by providing a free service, whereas users may be charged a fee to access map tags stored by other users. As an example, users may be able to create and store map tags of their personal points of interest. When a package delivery service that desires to employ the map tags to facilitate navigation may be charged a fee to access the map tags directory. Users may be able to add and share their map tags using client applications, websites, etc. The technology may also provide an application program interface that enables access the map tags directory, e.g., for integration with other applications.

In various embodiments, the technology can function with navigation services, e.g., mapping services, to provide guidance from a users present location to a geographic location associated with a specified map tag. As an example, a user may employ a navigation device (e.g., personal computer, GPS receiver, mobile phone, etc.) to find a route to a location associated with a map tag. Such a service may be useful to package delivery companies, taxi dispatch services, fast food delivery companies, customer service technicians, etc.

In various embodiments, the technology may enable users to locate services they are interested in that may be available near a location corresponding to a specified map tag.

In various embodiments, the technology may include capabilities for sending promotional messages, vouchers, notices, etc. to mobile devices based on their current location or other preferences. As an example, a vendor may identify its map tag and request that users who are within a specified distance of the specified map tag should receive various promotional messages.

In various embodiments, the technology enables people without permanent addresses from receiving packages, visitors, etc. As an example, a user may specify that a map tags associated with their present geographic location has indicated by a mobile phone's GPS location. When a delivery company needs to deliver a package to that user, the delivery company may route the package to the present location associated with the user's map tag.

In various embodiments, the technology may provide integration points with integrated development environments, e.g., so that software developers can easily build and deploy applications and services that integrate with map tags.

Thus, the technology enables users to identify personal points of interest (e.g., home, office, etc.) and securely share these points of interest with others. Because the directory is not associated with commercial interests whose business it is to provide profile information about users, e.g., for directed advertising purposes, it is believed that users will trust a map tag service. Because map tag names can be easy-to-remember monikers for locations that are controlled by their creators, they can be an easy and effective way to communicate and share location identifiers.

Several embodiments of the facility are described in more detail in reference to the Figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable media that may store instructions that implement the importance system. The storage devices can include, e.g., nontranistory storage media. In addition, the data structures and message structures may be stored or transmitted via a data transmission medium, such as a signal on a communications link. Various communications links may be used, such as the Internet, a local area network, a wide area network, or a point-to-point dial-up connection.

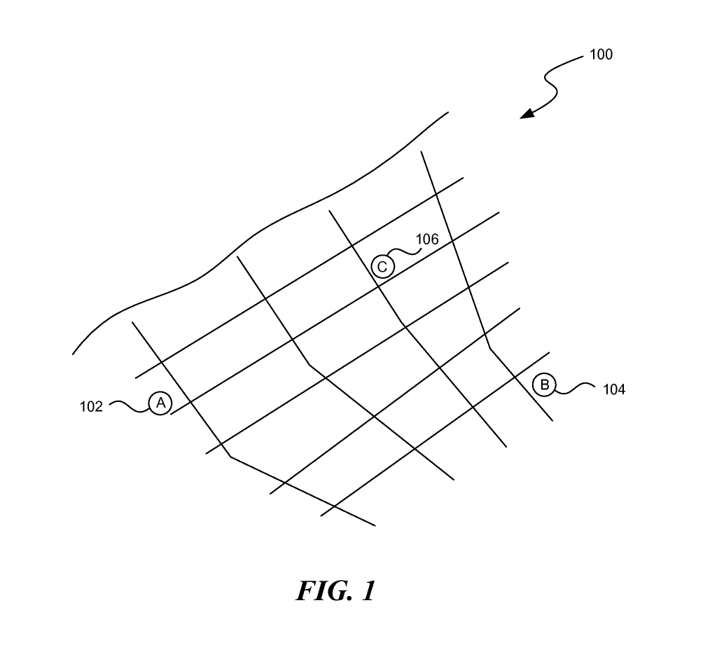

FIG. 1 is a map diagram illustrating a map 100 with some identified locations. The map identifies a first location 102, a second location 104, and a third location 106. The first location 102 represents a location at which a user is presently located. The second location 104 represents a location to which the user desires to go. The third location 106 represents a prominent location in relation to which navigation instructions may be specified for nearby locations. As an example, the second location 104 may be specified as “one block east and four blocks south of” the third location 106.

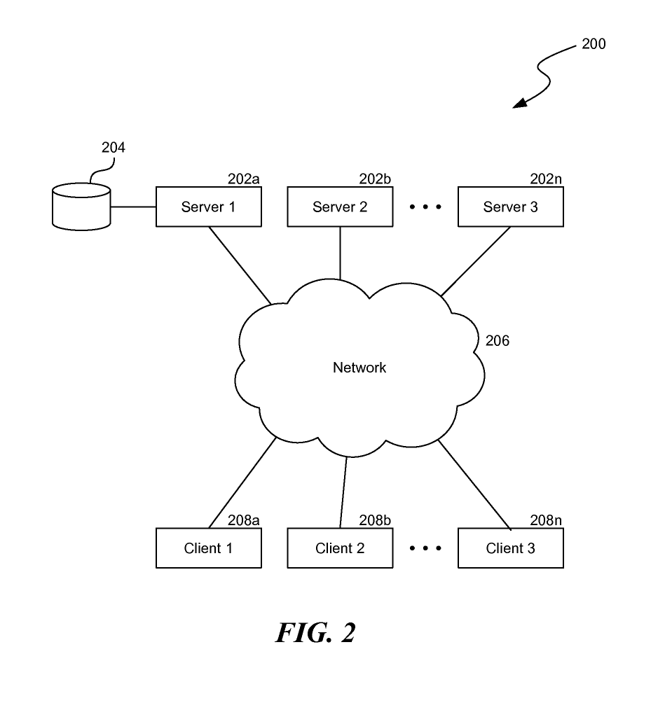

FIG. 2 is a block diagram illustrating components 200 employed by the technology in various embodiments. The components 200 can include one or more server computing devices 202a, 202b, and 202n. One or more of the server computing devices may have associated therewith a database, e.g., a database 204. In some embodiments, the database 204 may store a map tag directory. The server computing devices may be interconnected, e.g., via a network 206, with client computing devices, e.g., client computing devices 208a, 208b, and 208n. The network 206 can be an intranet, the Internet, or any other type of network or combination of networks. The client computing devices can be mobile phones, handheld computers, laptop computers, etc. These client computing devices may access map tag services via a Web browser, custom application, or application program interface accessed by a third party application or service.

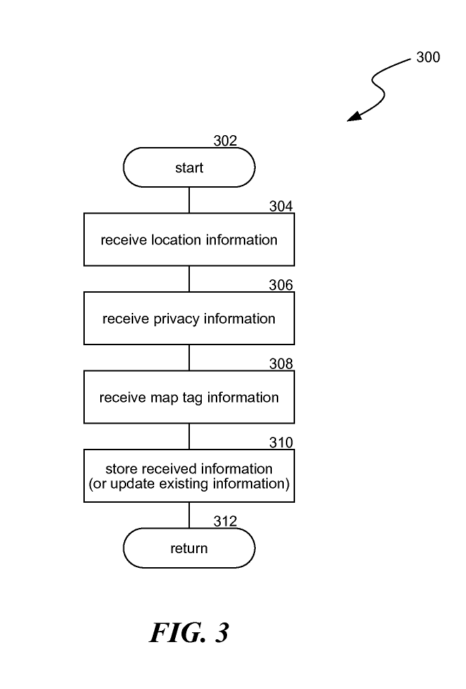

FIG. 3 is a flow diagram 300 illustrating a routine invoked by the technology in various embodiments, e.g., for receiving and storing information relating to a map tag. The routine 300 begins at block 302. At block 304, the routine receives location information. Examples of location information can include, e.g., GPS coordinates, landmarks, street intersections, directions, etc. Typically, the location information will include at least GPS coordinates. At block 306, the routine receives privacy information. As an example, the routine may receive information indicating which other users have what types of access to the location information or the map tag that is about to be created. As an example, the routine may receive privacy (or permissions) information relating to family members, friends, specified entities, and others. At block 308, the routine receives map tag information. As an example, the routine may receive an identification for the map tag. At block 310, the routine stores the received information, e.g., in a map tag directory. At block 312, the routine returns.

Those skilled in the art will appreciate that the logic illustrated in FIG. 3 and described above, and in each of the flow diagrams discussed below, may be altered in a variety of ways. For example, the order of the logic may be rearranged, substeps may be performed in parallel, illustrated logic may be omitted, other logic may be included, etc.

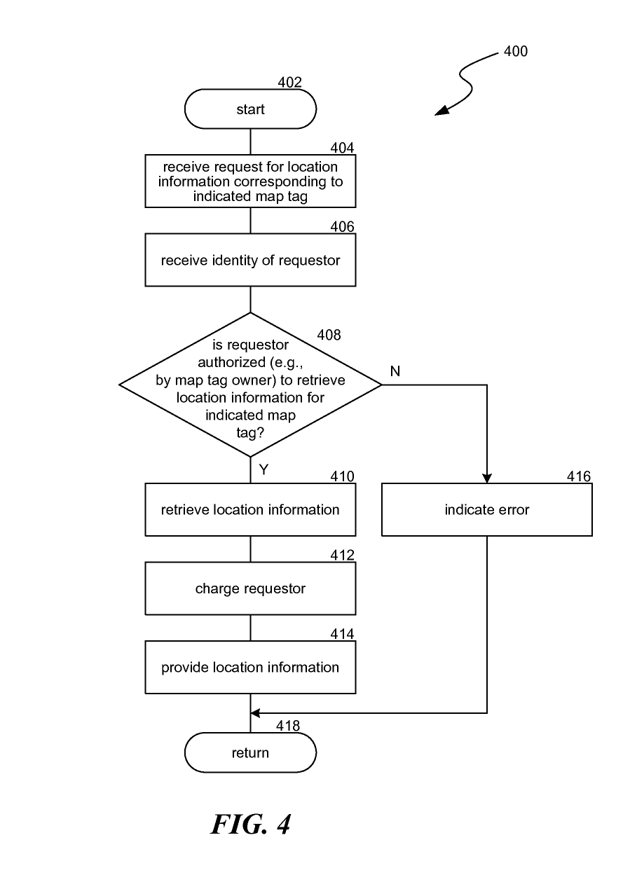

FIG. 4 is a flow diagram 400 illustrating a routine invoked by the technology in various embodiments, e.g., for providing location information associated with a specified map tag. The routine 400 begins at block 402. At block 404, the routine receives a request for location information core spawning twin indicated that tag. As an example, the routine may receive an indication of a map tag identifying a location to which a user desires to navigate. At block 406, the routine receives an identity of a user making the request. As examples, users employing a service may need to provide login credentials to receive full access to a map tag. If users do not provide their login credentials, they may receive minimal access to information relating to an indicated map tag. At decision block 408, the routine determines whether the requester is authorized, e.g., by a user who created the indicated map tag, to retrieve location information for the indicated map tag. In various embodiments, the routine may determine whether the requester is authorized by querying a map tag directory. If the requester is authorized, the routine continues at block 410. Otherwise, the routine continues at block 416. At block 410, the routine retrieves location information corresponding to the indicated map tag. At block 416, the routine indicates an error, e.g., indicating that the requester is not authorized, and returns at block 418. At block 412, the routine may cause the requester to incur a charge, e.g., for receiving the location information. In various embodiments, the technology may charge commercial entities or others that desire to employ aspects of the technology. At block 414, the routine provides the retrieved location information. At block 418, the routine returns.

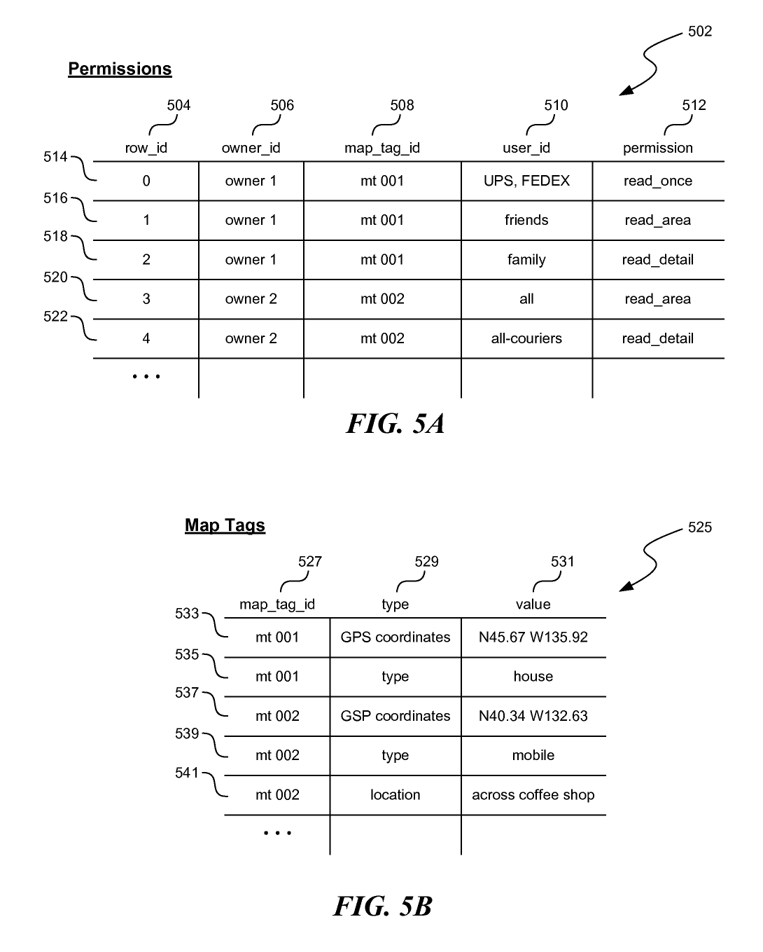

FIGS. 5A and 5B are table diagrams illustrating tables that may be employed by the technology in various embodiments, e.g., to store information relating to map tags. FIG. 5A illustrates a permissions table 502. The permissions table 502 illustrated includes a row identifier 504 column, and owner identifier 506 column, a map tag identifier 508 column, a user identifier 510 column, and a permission 512 column. Rows 514, 516, and 518 are associated with a first map tag owner and map tag; and rows 520 and 522 are associated with a second map tag owner and map tag. According to row 514, the first user has shared a map tag with UPS and FedEx delivery companies and has indicated that they can retrieve the map tag once. According to row 516, the first user has shared the first map tag with friends, but has indicated that the friends can only retrieve area information associated with the map tag. As an example, friends may be able to determine in which city the owner is presently in. According to row 518, the first owner has shared detail information with the owners family members. According to row 520, the second user has shared the second map tag with everyone, but they can only retrieve area information associated with the map tag. According to row 522, the second owner has shared all details with all couriers (e.g., delivery service companies).

FIG. 5B illustrates a map tags table 525. The map tags table 525 includes a map tag identifier column 527, a type column 529, and a value column 531. The map tag identifier column 527 has entries corresponding to the entries in the map tag identifier column 508 in the permissions table 502 illustrated in FIG. 5A. The type column 529 stores names associated with map tags. The names can be provided by users or identified by the system automatically. Rows 533 and 535 are associated with a first map tag owner and a first map tag; and rows 537, 539, and 541 are associated with a second map tag owner and a second map tag. Row 533 provides GPS coordinates corresponding to the first map tag. Row 535 identifies a type of location (house) corresponding to the first map tag. Row 537 provides GPS coordinates corresponding to the second map tag. Row 539 identifies a type of location (mobile) corresponding to the second tag. Row 541 identifies a descriptive location (across coffee shop) for the location corresponding to the second map tag.

While FIGS. 5A, 5B, and each of the table diagrams discussed below show tables whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; etc.

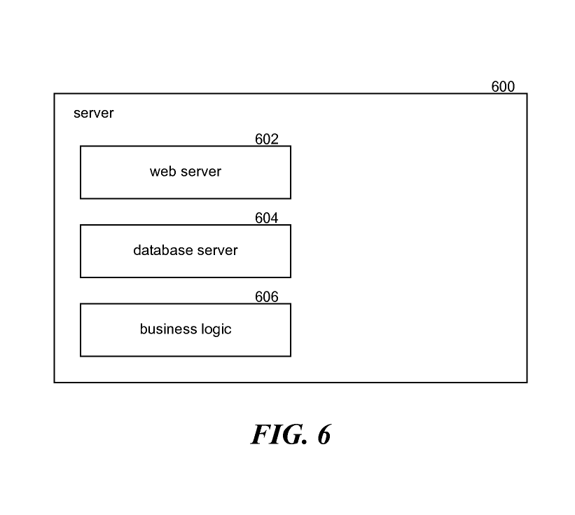

FIG. 6 is a block diagram illustrating components 600 employed by the technology in various embodiments. The component 600 may correspond to components of a server computing device, and can include a Web server 602, a database server 604, and the business logic component 606. The Web server component 602 can receive requests, e.g., from clients, and retrieve data from the database server 604 to satisfy the received requests. The Web server component 602 may correspond to a domain name associated with a map tag directory. The database server 604 may store a map tag directory. The business logic component 606 may be employed by clients and other services, e.g., to access data stored in the database server 604. The business logic component 606 can enforce business logic, e.g., permissions, and may also be employed to create, modify, delete, search, share, and view map tags.

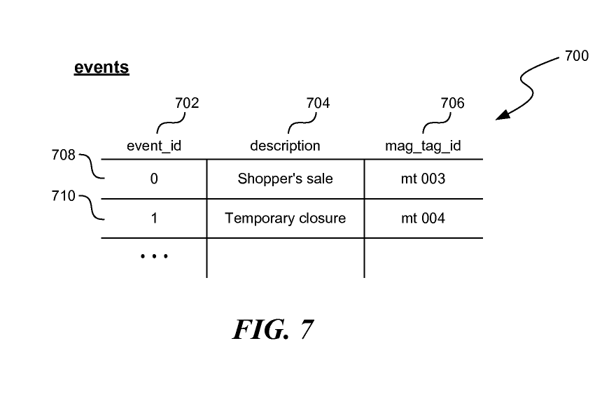

FIG. 7 is a table diagram illustrating an events table 700 that may be employed by the technology in various embodiments, e.g., to store events associated with map tags. The events table 700 can store various events, e.g., promotional events. The events table 700 can include an event identifier column 702, a description column 704, and a map tag identifier column 706. The map tag identifier: 706 can store map tags associated with each of the events. As an example, row 708 indicates a first event associated with a first map tag and row 710 indicates a second event associated with a second map tag.

Other data that may be associated with map tags and stored in the directory (not illustrated) are name, type, sub-type, version, partner (e.g., entity that may be promoting the map tag), owner, create date, update date, description, building name, house or apartment number, postal address (if available), user contact information, geo location, privacy indicators (e.g., listed, unlisted, closed user group and associated user identifiers), landmarks, arrows and arrow labels, lines and line labels, polygons and polygon labels, media (e.g., photo), etc.

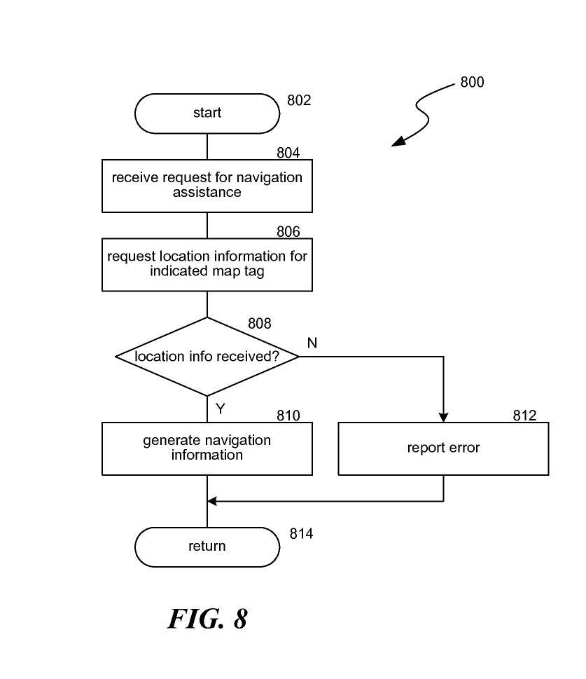

FIG. 8 is a flow diagram illustrating a routine 800 invoked by the technology in various embodiments, e.g., for providing navigation information to a location associated with a specified map tag. The routine 800 begins at block 802. At block 804, the routine receives a request for navigation assistance. The request for navigation assistance can indicate a map tag corresponding to a location to which navigation is desired. At block 806, the routine requests location information for the indicated map tag. At decision block 808, the routine determines whether the location information for the indicated map tag has been received. If the location information has been received, the routine continues at block 810. Otherwise, the routine continues at block 812. At block 810, the routine generates navigation information to a location corresponding to the indicated map tag. In various embodiments, the technology may use third party navigation services (e.g., GOOGLE, BING, etc.) to produce the navigation information. The routine then returns at block 814. At block 812, the routine reports an error indicating that location information could not be received. As an example, the location information may not be received if the user making the request does not have sufficient permission. The routine then continues at block 814, where it returns.

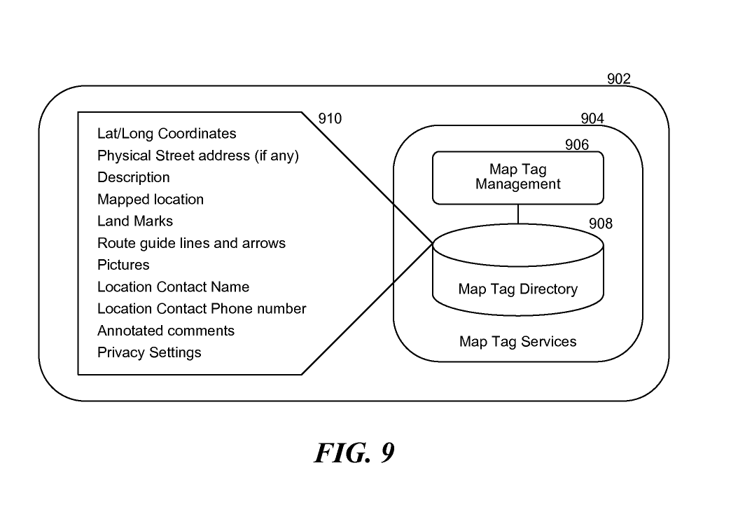

FIG. 9 is a block diagram illustrating components 902 employed by the technology in various embodiments. Components 902 can include map tag services component 904. The map tag services component 904 can include a map tag management component 906 and a map tag directory 908. The map tag directory 908 may be stored in the database. The map tag management component 906 can act as a business process component, e.g., to facilitate retrieval and storage of data in the 908. Associate with map tags, as partially listed in list 510. Other information (not illustrated) may also be stored in the map tag directory.

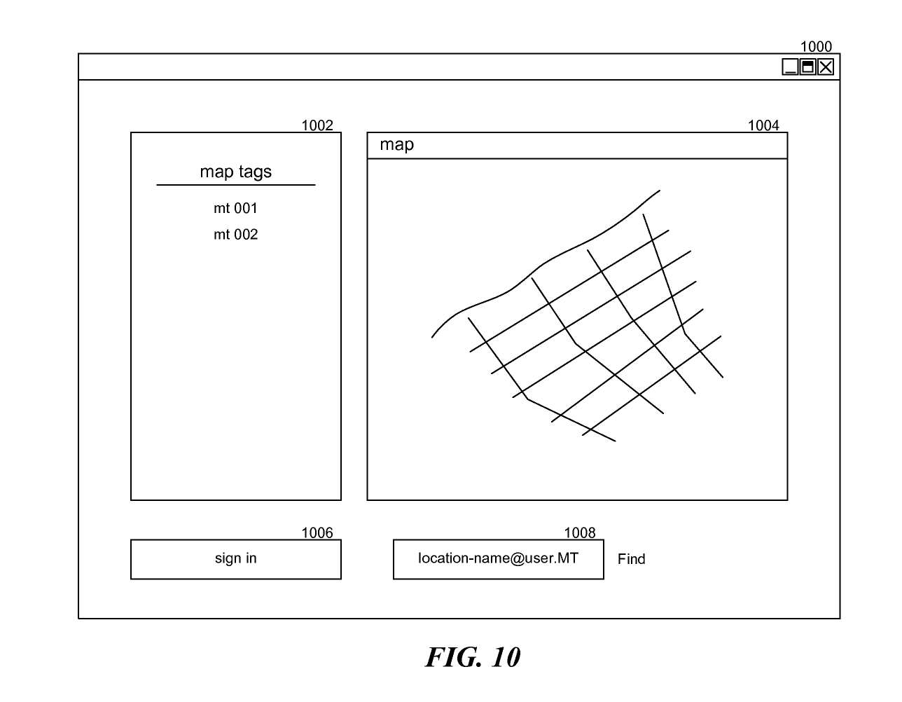

FIG. 10 is a user interface diagram illustrating a user interface 1000 provided by the technology in various embodiments. The user interface 1000 can include a list region 1002, a map region 1004, a sign in region 1006, and they find region 1008. The list region 1002 can provide a list of map tags. When the user selects an item in the list region 1002, a location corresponding to the selected item may be identified in a map displayed in region 1004. The user may then be able to select the identified location and request navigation services (not illustrated). The user may also sign in to the technology, e.g., by selecting a sign in region 1006. The user can then find map tags to which the user has access, e.g., by typing in a map tag identifier or name and then depressing a Find button. One skilled in the art would recognize that other features may also be added to the user interface and various features can be removed or modified to customize the functionality of the application.

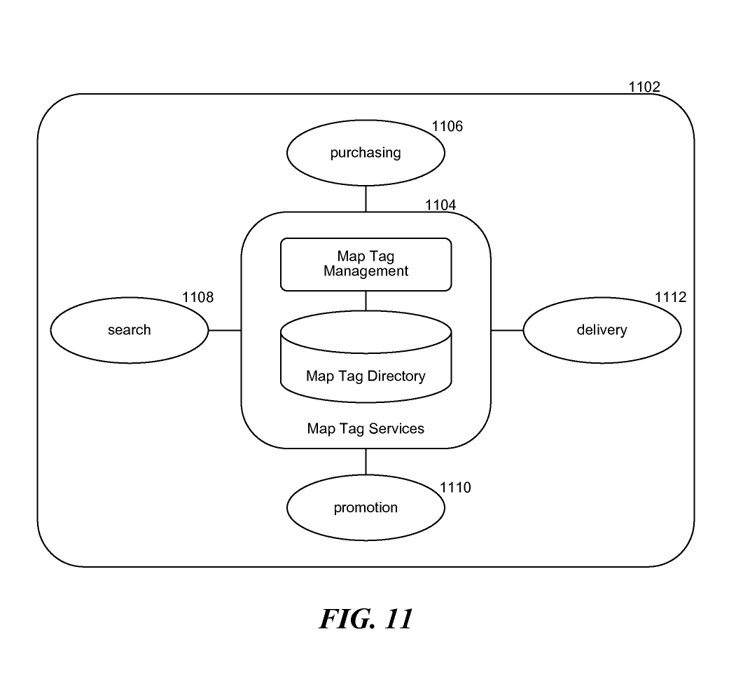

FIG. 11 is a block diagram illustrating components 1102 employed by the technology in various embodiments. The components 1102 can include a map tag services component 1104 (e.g., corresponding to map tag services component 904 illustrated in FIG. 9), a purchasing component 1106, a search component 1108, a promotion component 1110, and a delivery component 1112. Purchasing component 1106 may facilitate online transactions. Search component 1108 may facilitate identifying service providers near a specified map tag. Promotion component 1110 can facilitate promotions, e.g., by identifying users near a map tag location associated with a promotion. Delivery component 1112 can facilitate deliveries of packages, e.g., by interacting with business applications employed by delivery service companies.

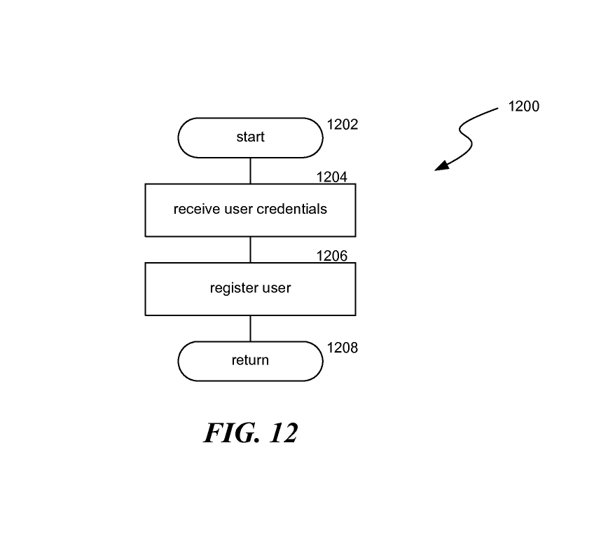

FIG. 12 is a flow diagram illustrating a routine 1200 invoked by the technology in various embodiments, e.g., for registering users. The routine 1200 begins at block 1202. At block 1204, the routine receives user credentials. As an example, the routine may receive the users identifier and password. At block 1206, the routine registers the user. As an example, the routine may verify the user's login credentials or store the log in credentials of the user has not previously registered. At block 1208, the routine returns.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

1. A method performed by a computing device to associate a map tag with a location, comprising:
receiving an identity of a creator;
receiving an indication of a geographic location;
receiving a name to be used as a moniker for the geographic location;
receiving permission information from the creator identifying at least one user who can access an aspect of the geographic location, wherein the aspect is at least one of an area or full details; and
storing, in a map tag directory that stores at least one other map tag, as a part of a newly created map tag associated with the creator, the received indication of the geographic location, name, and permission information;
receiving a request for the geographic location, wherein the request includes an identity of a requestor;
determining if the requestor has been given permission by the creator to access the aspect of the geographic location; and
if the requestor has been given permission by the creator to access the aspect of the geographic location, providing the aspect of the geographic location to the requestor to satisfy the request.

2. The method of claim 1, wherein the geographic location is a GPS location.

3-5. (canceled)

6. The method of claim 1, wherein the request is received via an application program interface and the requestor is a service provider.

7. The method of claim 1, further comprising providing navigation information to the requestor.

8. The method of claim 1, wherein the moniker includes a name, an owner, and a domain name.

9. The method of claim 8, wherein the domain name is not the same domain as a web service that provides a map tag service.

10. A computer-readable storage device storing computer-executable instructions that, when executed, associate a map tag with a location, comprising:
receiving an identity of a creator;
receiving an indication of a geographic location
receiving a name to be used as a moniker for the geographic location;
receiving permission information from the creator identifying at least one user who can access an aspect of the geographic location; and
storing, in a map tag directory that stores at least one other map tag, as a part of a newly created map tag associated with the creator, the received indication of the geographic location, name, and permission information.

11. The computer-readable storage device of claim 10, further comprising:
receiving a request for the geographic location, wherein the request includes an identity of a requestor;
determining if the requestor has been given permission by the creator to access an aspect of the geographic location; and
if the requestor has been given permission by the creator to access an aspect of the geographic location, providing the aspect of the geographic location to the requestor to satisfy the request.

12. The computer-readable storage device of claim 11, further comprising:
providing navigation information to the geographic location.

13. The computer-readable storage device of claim 11, wherein the moniker includes a name, an owner, and a domain name.

14. The computer-readable storage device of claim 11, wherein the request is received via an application program interface and the requestor is a service provider.

15. The computer-readable storage device of claim 11, wherein the request is received at a Web server.

16. A system for associating a map tag with a location, comprising:
a component configured to receive an identity of a creator;
a component configured to receive an indication of a geographic location
a component configured to receive a name to be used as a moniker for the geographic location;
a component configured to receive permission information from the creator identifying at least one user who can access an aspect of the geographic location; and
a component configured to store, in a map tag directory that stores at least one other map tag, as a part of a newly created map tag associated with the creator, the received indication of the geographic location, name, and permission information.

17. The system of claim 16, further comprising a business process component configured to receive requests from one or more clients and manage interactions with the map tag directory.

18. The system of claim 16, further comprising a management component configured to:
receive a request for the geographic location, wherein the request includes an identity of a requestor;
determine if the requestor has been given permission by the creator to access an aspect of the geographic location; and
if the requestor has been given permission by the creator to access an aspect of the geographic location, provide the aspect of the geographic location to the requestor to satisfy the request.

19. The system of claim 18, wherein the request is received via an application program interface and the requestor is a service provider.

20. The system of claim 18, wherein the request is received from a mobile phone.
